(19) United States
(12) Patent Application Publication
(10) Pub. No.: US 2007/0108030 A1
(43) Pub. Date: May 17, 2007

(54) Handheld electronic communication device with metallic keypad

(75) Inventors: Eric Dalla Ricca, Saint-Vast en Chaussee (FR); Alain Guirauton, Argenteuil (FR); Lydie Robert, Antony (FR)

Correspondence Address: MORGAN LEWIS & BOCKIUS LLP, 1111 PENNSYLVANIA AVENUE NW, WASHINGTON, DC, 20004, US

(73) Assignee: TCL Communcation Technology Holdings Limited

(21) Appl. No.: 11/542,638

(22) Filed: Oct. 4, 2006

(30) Foreign Application Priority Data
Oct. 5, 2005 (EP) 05 109 223.7

(51) Int. Cl. H01H 13/00

(52) U.S. Cl. 200/329

(57) ABSTRACT

The present invention relates to a handheld electronic communication device comprising, in a housing (1), a printed circuit board (2) for holding electrical components and providing several connection points, and a keypad (5) extending parallel to said printed circuit board (2) and including a keypad user's interface (5c), made of a metallic sheet, said device further comprising a radio communication module for transmitting and/or receiving signals, said radio communication module being connected to a radiating element via an antenna's feeding point on printed circuit board (2). According to the invention, said metallic sheet is provided with at least a connection area (5e) electrically connected to said antenna's feeding point of said printed circuit board (2), and said metallic sheet further comprises a slot (8), said keypad user's interface (5c) constituting then said radiating element whose working frequencies depend on the shape and the size of said slot.

The present invention concerns a handheld electronic communication device comprising, in a housing, a printed circuit board for holding electrical components and providing several connection points, and a keypad extending parallel to said printed circuit board and including a keypad user's interface.

Such structural features can be found today in a great number of portable devices, such as PDA (Personal Digital Assistant), phones like GSM phones or DECT phones, or even Personal Computers.

Manufacturers for this kind of devices always look for solutions which enable either to reduce to the maximum the size and weight of the device, or, for a given size, to increase the functionalities of the device.

An important issue relates to devices for which an antenna is needed for radio communication purposes. In such cases, the radiating element which constitutes a part of the antenna is also a specific metallic feature, generally provided with an internal patch antenna, for which the dedicated space is important (up to 5 cm³ in the case of a triband mobile phone).

The external appearance of such devices becomes also an important criterion for consumers purchasing said device. Some mobile phones have recently been proposed with a keypad entirely made of a metallic sheet.

The aim of the invention is to provide a solution which meets both the bulk constraints and the aesthetic requirements.

To this aim, an object of the present invention is a handheld electronic communication device comprising, in a housing, a printed circuit board for holding electrical components and providing several connection points, and a keypad extending parallel to said printed circuit board and including a keypad user's interface, made of a metallic sheet, said device further comprising a radio communication module for transmitting and/or receiving signals, said radio communication module being connected to a radiating element via an antenna's feeding point on printed circuit board, characterized in that said metallic sheet is provided with at least a connection area electrically connected to said antenna's feeding point of said printed circuit board, and in that said metallic sheet further comprises a slot, said keypad user's interface constituting then said radiating element whose working frequencies depend on the shape and the size of said slot.

Said slot may be advantageously designed to separate metallic sheet into two electrically isolated parts, a first part provided with said connection area electrically connected to said antenna's feeding point of said printed circuit board, and a second part provided with a second connection area electrically connected to a ground connection of said printed circuit board for constituting a shield against electrostatic discharge phenomena.

Other features and advantages of the invention will become apparent from the following description with reference to the accompanying drawings, in which:

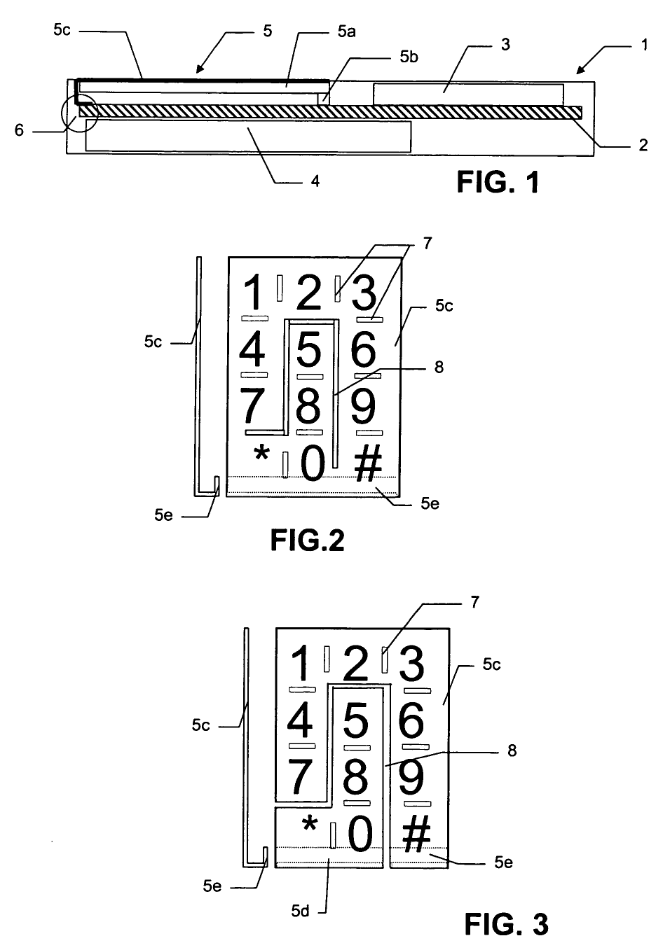

FIG. 1 shows schematically a sectional longitudinal view of a device according to the invention;

FIG. 2 shows schematically front and side views of metallic sheet in an embodiment in which the keypad is used as an antenna radiating element only;

FIG. 3 shows schematically front and side views of metallic sheet in a second embodiment in which the keypad is used both as a shield against electrostatic discharges and as an antenna radiating element.

As shown on FIG. 1, the electronic communication device according to the present invention comprises a housing 1 which is generally of parallelepiped shape and made of plastic material. Housing 1 classically comprises a printed circuit board 2 for carrying different electronics components of the device, such as but not limited to a display 3, for instance a LCD. The housing also comprises a battery 4 for supplying voltage to different components, via printed circuit board 2. To this aim, printed circuit board 2 is electrically connected to said battery 4, and comprises, as known, several specific points or printed electrical tracks including energy connection and ground connection (not shown). At last, the device comprises a keypad 5 which extends parallel to printed circuit board 2. In FIG. 1, keyboard 5 extends only over a part of printed circuit board 2, and display 3 extends parallel over the remaining part of printed circuit board. More precisely, keypad 5 comprises a keypad module 5a, which can be held by housing 1, and which comprises contacts or domes (not shown) which can be switched off or on, depending whether a user has pressed or not a corresponding key. Keypad 5 also comprises a connection module 5b for connecting keypad module 5a to printed circuit board 2. Consequently, each time a key is pressed by a user, a microprocessor (not shown) on printed circuit board 2 can receive this information and trigger a corresponding action on the device.

According to an essential feature of the invention, keypad 5 also comprises an external metallic sheet 5c which covers keypad module 5a so as to constitute an external user's interface, and which is electrically connected to printed circuit board 2. The electrical connection is schematically shown by area 6 on FIG. 1. Depending on the choice of the electrical point(s) or track(s) on PCB 2 to which said metallic sheet 5c will be connected, this feature will thus enable to give to the keypad an additional functionality, as explained in details hereinafter.

In the specific embodiment of FIG. 2, metallic sheet 5c is to be used as a radiating part of an antenna. In this case, portable device comprises, on PCB board 2, a radio communication module (not shown) for wireless transmission and/or reception of signals. As well known in the art, output and/or input of this radio communication module constitutes what is known as an antenna's feeding point on the PCB, to which a radiating element must be connected. According to the invention, metallic sheet 5c comprises a connection area 5e, which is used, in the embodiment of FIG. 2, for electrical connection of metallic sheet 5c to the antenna's feeding point (not shown) on the PCB. In addition, as illustrated on FIG. 2, metallic sheet 5 c further comprises a coplanar slot 7 in the thickness of sheet 5c. Consequently, said keypad also constitutes an antenna whose working frequencies depend on the shape and size of said slot. The width of slot 8 will preferably be as small as possible in order to be barely visible to the naked eye.

Consequently, thanks to the use of a metallic keypad sheet 5c with slot 8, and with adequate electrical connection to PCB, there is no need to provide the device with a separate antenna which, in known solutions, generally requires an important dedicated space.

Embodiment shown on FIG. 3 is a second embodiment in which the keypad is used both as a shield against electrostatic discharges and as an antenna radiating element. In this case, slot 8 is designed in order to separate metallic sheet 5c in two parts which are electrically isolated one from each other. Each part includes a connection area, one, with reference 5d, which is used for electrical connection to ground point on PCB, the other, with reference 5e being used for electrical connection to antenna's feeding point on the PCB. Accordingly, the same keypad user's interface in the form of a metallic sheet 5c can be used as a protection against Electrostatic Discharges phenomena, and as an antenna. Consequently, extra cost and extra thickness which would be necessary with prior art solutions are here avoided.

In all embodiments disclosed above, metallic keypad provides also the functionality of another element (antenna alone or antenna and ESD shield), thus leading to an optimized bulk.

In addition, the use of a metallic keypad enables, in term of external design, to have a very trendy appearance.

In all embodiments disclosed here above, connection areas 5d and 5e have been represented as U-shaped bent portion of metallic sheet 5c. Other connections can be used in the same spirit in order to connect metallic sheet 5c to ground point and/or antenna's feeding point on PCB.

1. Handheld electronic communication device comprising, in a housing (1), a printed circuit board (2) for holding electrical components and providing several connection points, and a keypad (5) extending parallel to said printed circuit board (2) and including a keypad user's interface (5c), made of a metallic sheet, said device further comprising a radio communication module for transmitting and/or receiving signals, said radio communication module being connected to a radiating element via an antenna's feeding point on printed circuit board (2), characterized in that said metallic sheet is provided with at least a connection area (5e) electrically connected to said antenna's feeding point of said printed circuit board (2), and in that said metallic sheet further comprises a slot (8), said keypad user's interface (5c) constituting then said radiating element whose working frequencies depend on the shape and the size of said slot.

2. Handheld electronic communication device according to claim 1, characterized in that said slot (8) is designed to separate metallic sheet (5c) into two electrically isolated parts, a first part provided with said connection area (5e) electrically connected to said antenna's feeding point of said printed circuit board (2), and a second part provided with a second connection area (5d) electrically connected to a ground connection of said printed circuit board (2) for constituting a shield against electrostatic discharge phenomena.
